(19) United States
(12) Patent Application Publication
(10) Pub. No.: US 2010/0179815 A1
(43) Pub. Date: Jul. 15, 2010

(54) Phronesis Antenarrating Methodology for analyzing, intervening, developing, maintaining and/or controlling organizational and/or social processes and/or practises. A specific type of it being the Phronetic antenarrating methodology, being either part of or specific practise of phronesis antenarrating methodology

(76) Inventor: Wilfred Berendsen, Lichtenvoorde (NL)

Correspondence Address: W.T.M. Berendsen, Middachtenstraat 53, Lichtenvoorde, Gelderland, 7131 GE, NL

(21) Appl. No.: 12/354,046

(22) Filed: Jan. 15, 2009

(51) Int. Cl. G06Q 10/00

(52) U.S. Cl. 705/1.1

(57) ABSTRACT

Organizational and social processes and practises are key in every act and activity of organizations in our society as such. The phronesis antenarrating methodology as developed by the inventor is a methodology for analyzing, intervening, developing, maintaining and/or controlling organizational and/or social processes and practises. Based on, but not limited to, phronesis and (aspects of) practicism. And based on and aimed at further development and growth of phronesis representia. Phronesis antenarrating is in line with a lot of the findings mentioned in the discourse “a phronesis antenarrative-towards new ecosocial systems through the logic of vagueness” This discourse is created and written by the inventor of phronesis antenarrating. The methodology described in this patent, together with critical aspects of it being the phronesis representia and pluriflection, is not described in this discourse yet. But it will be in near future. Just like every new concept and methodologies invented and/or created by the inventor of Phronesis Antenarrative, Phronesis Antenarrating, Phronetic antenarrative, Phronetic antenarrating, Practicism and insights belonging to this line of thinking will be. The inventor and creator of “A phronesis antenarrative” being W. T. M. Berendsen. W. T. M. Berendsen is born in Lichtenvoorde, the Netherlands, on Nov. 9, 1973.

A Phronesis Antenarrating Methodology for analyzing, intervening, developing, maintaining and/or controlling organizational and/or social processes and/or practises. A specific type of it being the Phronetic antenarrating methodology, being either part of or specific practise of phronesis antenarrating methodology.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### REFERENCE TO SEQUENCED LISTING, A TABLE, OR A COMPUTER PROGRAM LISTING COMPACT DISC APPENDIX

Not applicable

### BACKGROUND OF THE INVENTION

The invention follows from the initial invention of antenarrating by David Boje. Then W. T. M. Berendsen invented the notion of Phronesis Antenarrating in his discourse “A phronesis antenarrative, towards new ecosocial systems through the logic of vagueness” (Further on referred to as “a phronesis antenarrative” in this specification). Some of the insights and notions elementary for the methodologies mentioned in this patent are reflected in “a phronesis antenarrative”. But, the methodologies themselves and also very elementary aspects of it (like the phronesis representia and pluriflection) are not mentioned there yet. The methodologies this patent should cover being the methodologies of Phronesis antenarrating, Phronetic antenarrating, Phronesis antenarrative and Phronetic antenarrative. Antenarrative and antenarrating should be considered as being synonyms in these notions, while Phronesis and Phronetic is that much interconnected that it is neither useful nor desirable to separate the two notions in whatever ways. The only slight but important differences between phronesis and phronetic as used in the methodologies reflected in this patent being the fact that phronesis is more elementary and created by single persons, while phronetic is more collaborative and created by several persons. When applying both phronesis and phronetic antenarrating, either one of the both or a combination of the both can be applied and used for specific cases and situations.

The problem with the “prior art” being the methodologies available at the moment is that they are mostly by far not as good as phronesis antenarrating for the task of analyzing and improving complex social processes and realities. The antenarrating methodologies in general can solve this, but for doing so a sound antenarrating methodology is needed. Which is what this newly invented and created methodology invented by W. T. M. Berendsen, can offer. Not only phronesis antenarrating and phronetic antenarrating but also the most important elements of it being phonesis representia and plurflection are all created by the inventor. Also the notion of holoplurality is a creation of the inventor, although it (aims to) represent the sole true structure and nature of our universes.

### FIELD OF THE INVENTION

The present invention generally relates to (change) management, organizational and social practises and business consulting. More specifically, the present invention offers a new and great tool for analyzing, intervening, developing, maintaining and/or controlling organizational and social processes and practises. The invention being the phronesis antenarrating methodology and phronetic antenarrating methodology as described and reflected in this patent. This methodology is very distinct from any other methodology, mainly because it is much more plural and also it is based on a very specific understanding of the structure and nature of our universes.

This phronesis antenarrating methodology enables a much better understanding of our social realities. By that, I offers a great methodology to improve (almost) everything with a social component in it. Because of the nature and contents of phronesis antenarrating, this methodology is generally much better and also leading to better results than any other methodology when a thorough understanding of complex social situations is needed. Further more, this phronesis antenarrating methodology is an excellent methodology for improving social processes and realities.

Whenever the notion of phronetic antenarrative and/or phronetic antenarrating are used in this patent, it should be clear that in this patent:
a) Antenarrating and Antenarrative, as used in the light of this patent and the methodologies expressed here, have to be considered as being synonyms
b) Phronetic antenarrative methodology and phronetic antenarrating methodology are specific types of phronesis antenarrative methodology and phronesis antenarrating methodology. Some elementary and relevant differences between the two notions and practises requires them to be distinguished, but in the end phronetic antenarrative is a critical part of phronesis antenarrating. Besides this, the differences between phronetic antenarrating and phronesis antenarrating are arbitrarily and sometimes difficult to point out in practise. Which is why a patent for phronesis antenarrating should naturally include phonetic antenarrating. There is no way to separate the both, as phronetic antenarrating is an elementary and essential feature of phronesis antenarrating. Meaning that in practise, phronetic antenarrating will be a part of phronesis antenarrating. Although phronetic antenarrating can be executed separately from phronesis antenarrating and not all phronesis antenarrating is always incorporating phronetic antenarrating.

### OTHER REFERENCES

Barge, J. K. (2004) ‘Antenarrative and Managerial Practice’, Communication Studies 55(1): 106-27.
Berendsen, W. T. M. “A phronesis antenarrative-towards new ecosocial orders through the logic of vagueness” (2006 till 2008, all the versions written by the author)
Boje, D. M. 2001a. Narrative Methods for Organizational and Communication Research. London: Sage.
Boje, D. M. (2001b). Flight of Antenarrative in Phenomenal Complexity Theory, Tamara, Storytelling Organization Theory. September 20th, paper to honor Professor Hugo Letiche and his work on Phenomenal Complexity Theory, for the September 24th and 25th Conference on Complexity and Consciousness at Huize Molenaar (Korte Nieuwstraat 6) in the old center of Utrecht, Netherlands. [1]
Boje, D. M. (2001c). “Antenarrating, Tamara, and Nike Storytelling.” Paper prepared for presentation at “Storytelling Conference” at the School of Management; Imperial College, 53 Prince's Gate, Exhibition Road, London, Jul. 9, 2001. On line at [2]
Boje, D. M. 2002. “Critical Dramaturgical Analysis of Enron Antenarratives and Metatheatre”. Plenary presentation to 5th International Conference on Organizational Discourse: From Micro-Utterances to Macro-Inferences, Wednesday 24th-Friday 26th July (London).
Boje, D. M. & Rosile, G. A. 2003. “Life Imitates Art: Enron's Epic and Tragic Narration”. Management Communication Quarterly, 17(1), 85-125.
Boje, D. M. (2007a). Chapter 13 Living Story: From Wilda to Disney, pp. 330-354. Handbook of Narrative Inquiry: Mapping a New Methodology. Edited by Jean Clandinin, London: Sage.
Boje, D. M. (2007b). The Antenarrative Cultural Turn in Narrative Studies” in Mark Zachry & Charlotte Thralls (Eds.) Communicative Practices in Workplaces and the Professions: Cultural Perspectives on the Regulation of Discourse and Organizations.
Boje, D. M. (2007c). Globalization Antenarratives. Pp. 505-549, Chapter 17 in Albert Mills, Jeannie C. Helms-Mills & Carolyn Forshaw (Eds). Organizational Behavior in a Global Context. Toronto: Garamond Press. [4]
Boje, D. M.; Rosile, G. A.; & Gardner, C. L. 2007. “Antenarratives, Narratives and Anaemic Stories” Chapter 4, pp. 30-45, Storytelling in Management, Editors: Ms. Nasreen Taher and Ms. Swapna Gopalan, Publisher: The Icfai University Press, India, First Edition: 2007 (Note: was based upon Paper presented in Showcase Symposium, Academy of Management,. Mon Aug. 9 2004 in New Orleans). See conference version [7]
Collins, D. & Rainwater, K. 2005. “Managing change at Sears: a sideways look at a tale of corporate transformation”. Journal of Organizational Change Management, 18(1): 16-30.
Czarniawska, B. 1997. Narrating the Organization: Dramas of Institutional Identity. Chicago: University of Chicago Press.
Czarniawska, B. 1998. “A Narrative Approach to Organization Studies”. Qualitative Research methods Series Vol. 43. Thousand Oaks, Calif.; Sage Publications, Inc.
Czarniawska, B. (2004). Narratives in social science research: London: Sage
Currie, M. (1998). Postmodern narrative theory. NY St. Martin's Press Czarniawska, B. (2004). Narratives in social science research: London: Sage

### BRIEF SUMMARY OF THE INVENTION

This invention is for the methodology of phronesis and phronetic antenarrating. Wherever antenarrating is used in these methodologies, this word can also be replaced by antenarrative. The phronesis antenarrating methodology and practise is aimed at (re) formulating and creating the most entelychistic Phronesis representia. This phronesis representia are reflected in a phronesis antenarrative. Then this phronetic representia and phronesis antenarrative are used for analyzing, intervening, developing, maintaining and/or controlling organizational and social processes. Either directly, or indirectly through phronetic antenarrating (see FIG. 1).

### BRIEF DESCRIPTION OF THE SEVERAL VIEWS OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of the structure and steps of phronesis and phronetic antenarrating methodology

FIG. 2 is a schematic illustration of possible inputs and elements of phronesis and phronetic antenarratives and antenarrating; inputs and elements are NOT limited to this possible/example inputs. Also phronesis and phronetic antenarratives and antenarrating do NOT have to incorporate ALL of the possible inputs and elements mentioned in this figure.

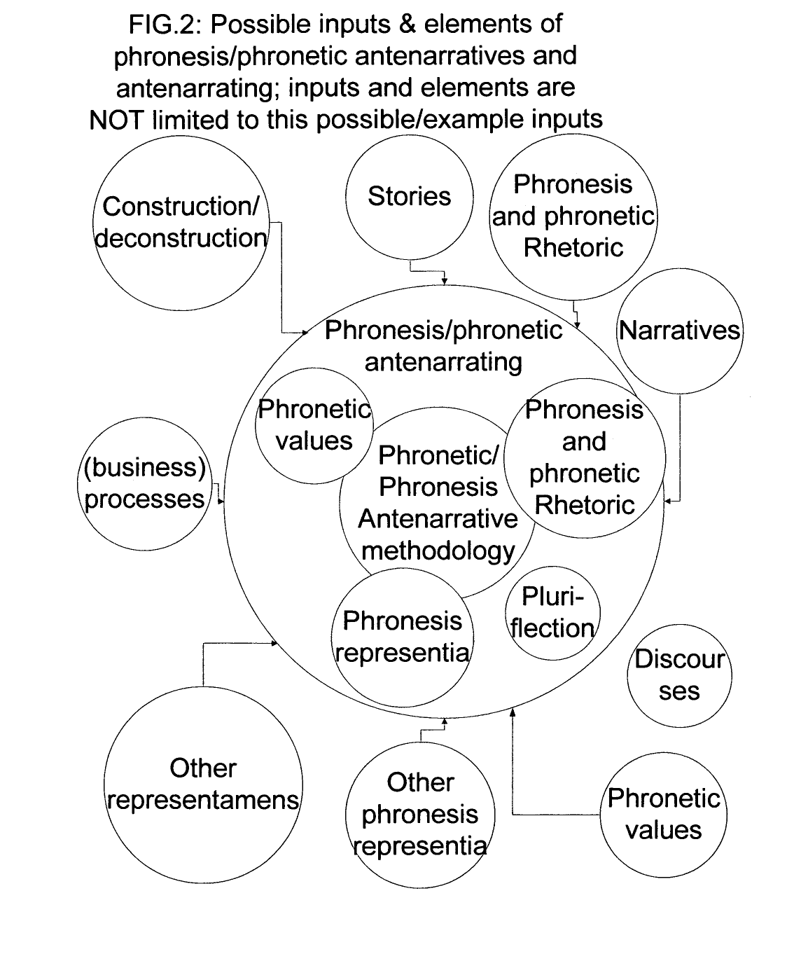

FIG. 3 is a schematic illustration of the aspects and nature of phronesis/phronetic antenarrating methodology

FIG. 4 is a schematic illustration of the aspects and nature of sound pluriflection(s) and mind process(ses)

FIG. 5 is a schematic illustration of (aspects of) phronesis representia

FIG. 6 is a schematic illustration of some exemplary social situations for which a phronesis antenarrating methodology can be used;

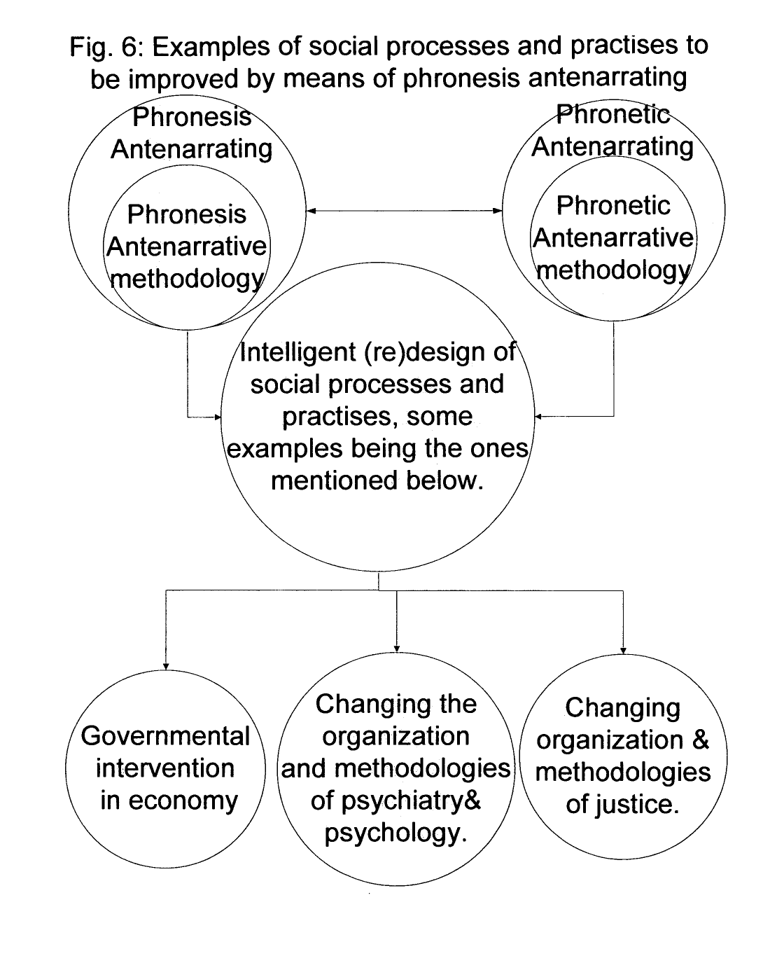

### DETAILED DESCRIPTION OF THE INVENTION

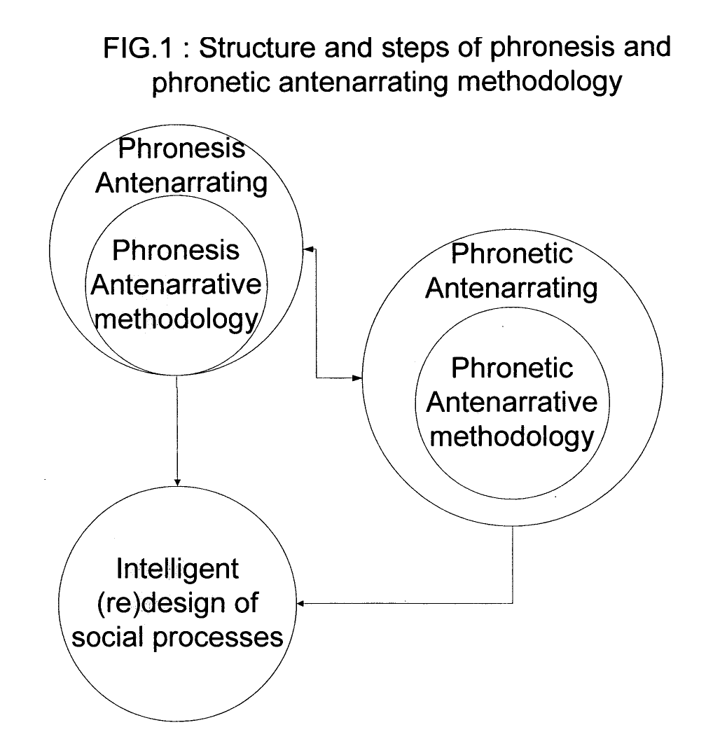

The invention is A Phronesis Antenarrating Methodology for analyzing, intervening, developing, maintaining and/or controlling organizational and/or social processes and/or practises. A specific type of it being the Phronetic antenarrating methodology, being either part of or specific practise of phronesis antenarrating methodology (FIG. 1).

Phronesis antenarrating and phronetic antenarrating are both based on the following fundamental notions and understandings:
Phronesis in general
Phronesis representia, being the plural of a Phronesis representamen
(Phronesis) pluriflection
Practicism/Practisism (being synonyms when used in this patent)
Phronesis) holoplurality, being the sole true structure of our universes

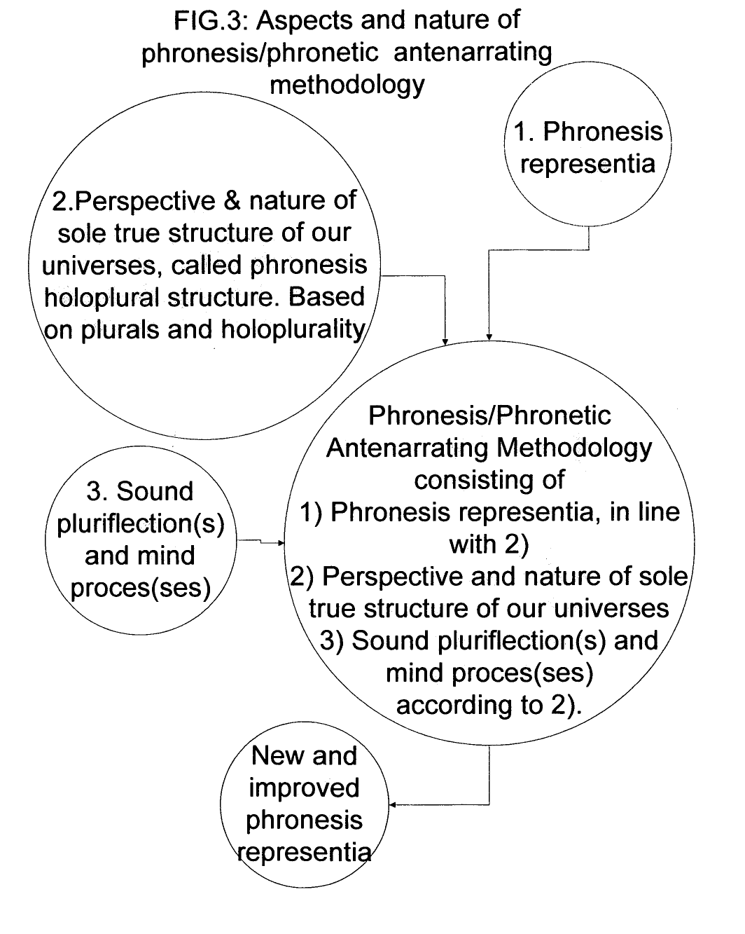

This fundamental notions are all either fundaments or critical parts of phronesis antenarrating methodology. As such, they are also essential parts of this patent. Phronesis in general and Practicism are important general notions for the nature and context of phronesis antenarrating methodology and phronetic antenarrating methodology. Meaning that practicism, phronesis in general and (phronesis) holoplurality, as explained in near future in “a phronesis antenarrative”, are at least major parts of the context for phronesis and phronetic antenarrating. Phronesis representia are both the fundaments for phronesis antenarrating and the outcome/result of it. By means of sound (phronesis) pluriflection based on phronesis representia, understandings of (parts of) our social processes and universes in general will grow. This results in, hopefully, a better phronesis understanding and wisdom. Being a better fundament for changes and improvement in social processes and practise. Partly being reflected in better and/or new phronesis representia. In FIG. 3, the nature of phronesis antenarrating and some of the most relevant aspects of it are being mentioned. Being the nature of holoplurality, and the aspects of Phronesis representia and sounds pluriflections and mind processes.

The (phronesis) holoplural structure of our universes is a very fundamental understanding. The nature of this (phronesis) holoplural structure being (phronesis) holoplurality. This nature of our universes can not be reflected completely in the phronesis representamen called (phronesis holoplurality), since quite some characteristics of it are part of phronesis understandings, and also this understandings can and will grow. But, in its essences, (phonesis) holoplural structure(s) is about the understanding that our universes consist of pluralities. Uniform notions may exist, but these are representamens or phronesis representia for plural realities and existences in our universes as such. These existences, being signs, are interconnected or not. But if they are connected, they are in less or more tight ways. Also really each of the existences, signs, in our universes are related to at least some other signs in our universes. And, in general, this connections can and will be multiplural.

A phronesis representamen is a very specific type of representamen. A representamen being, following Peircean semiotics:
“A sign, or representamen, is something which stands to somebody for something in some respect or capacity. It addresses somebody, that is, creates in the mind of that person an equivalent sign, or perhaps a more developed sign. That sign which it creates I call the interpretant of the first sign. The sign stands for something, its object. It stands for that object, not in all respects, but in reference to a sort of idea, which I have sometimes called the ground of the representamen. “(A Fragment, CP 2.228, c. 1897).

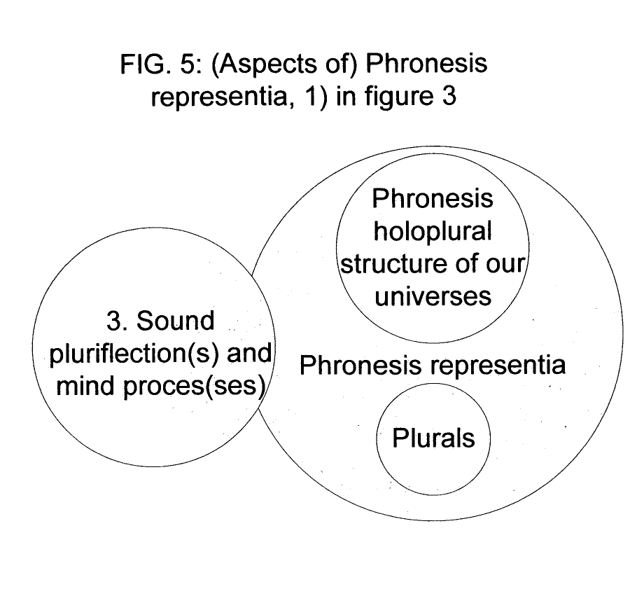

The phronesis representia are however a specific type of representamen being more excellent than a representamen in general. This because of the fact that it is based on the sole true right structure of our universes, being phronesis holoplurality. Further on, the most excellent mind processes being called (phronesis) pluriflection(s), are fundamental to use, create and improve phronesis representia. In FIG. 5 this is visualised, by means of mentioning the following critical aspects of phronesis representia:
Plurals
Pluriflection(s)
Phronesis holoplural structure of our universes

Phonesis representia consist of plurals instead of, what I call, uniplurals. Uniplurals being what is commonly referred to as uniformity. I say uniformity is mere perception, as uniform notions exist but realities of our universes are always plural. That is why I call some kinds of this notions uniplural notions. This notions are maybe considered and understood as plural notions, but still grounded on a wrong understandings. This wrong understanding being a wrong understanding of the true structure of our universes and/or based on too less real phronesis. In general, at least notions belonging to what I call traditionalist social sciences belong to this. And as this is mainstream in both social sciences and practises, about all the representamen in our society are actually representamen and what I call uniplurals. They HAVE to be converted into phronesis representia for more sane social sciences and practises. This is key for practisism, which is the ultimate integration of science and practise. By eliminating the insanities of and in our universes, or at least as much as possible at certain periods in time and following certain contexts.

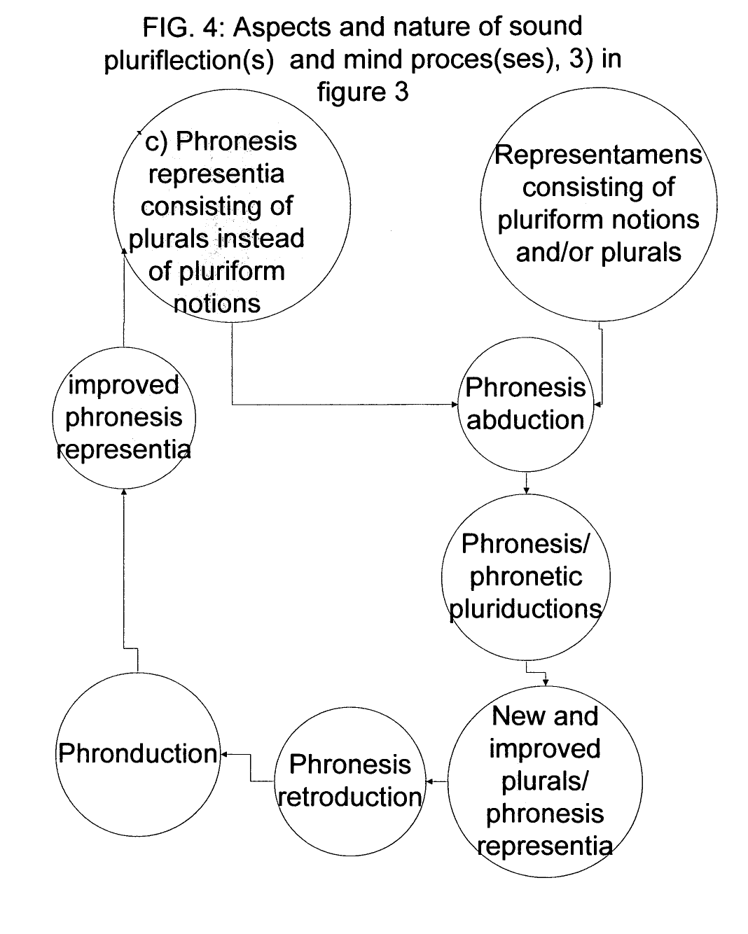

Then in FIG. 4, the aspects and nature of sound (phronesis) pluriflection(s) is being visualised. At least the following aspects and nature of pluriflection are important:
Phronesis abduction, phronesis and phronetic pluriduction(s), Phronesis retroduction and Phronduction.
Phronesis respresentia consisting of plurals instead of plurform notions
Phonetic actors with phronesis wisdoms excecuting the mind processes and pluriflections

Abduction and retroduction are also derived from Peircean notions, but based on phronesis antenarrating and phronesis pluriflections the inventor of phronesis antenarrating, being me, created some more excellent phronesis representia out of common representamens. Being the phronesis abduction and phronesis retroduction. This are very specific types of abduction and retroduction belonging to (phronesis) pluriflection (s). And the meaning of both phronesis abduction and phronesis retroduction are very different from the meaning of abduction and retroduction in Peircean senses.

In general, whenever the notions of phronesis pluriflections and pluriflections are used in this patent, they are exact the same concepts, synonyms for the same phenomenon. Both are themselves phronesis representia the inventor created himself. Based, again, on sound pluriflections. So in this case the phenomena was there but a sound phronesis representamen still had to be created.

Then also I added the notions of phronesis and phronetic pluriduction and the notion of phronduction. This was needed to make the pluriflection process complete. Meaning that, in light of phronesis pluriflection(s), at least the following notions are needed:
1) Phronesis abduction, the first stage of pluriflection. Phronesis abduction is NOT what is generally understood as being abduction. Phronesis abduction is most generally “just” the mere act of moving away from the subjects of pluriflection. This moving away can mean a physical moving away from the subject, a mind based moving away or just any combination or instance of moving away from. Towards another surrounding or context or whatever, just any context being different in whatever ways. Enabling anothernesses and plurisigns (pluriform signs) to enter the scene.
2) Phronesis and phronetic pluriduction, which are the mind processes and actual core of pluriflection. Based on a thorough understanding of phronesis, the holoplural structure of our universes and the subject under considerations, anothernesses critical and/or important for the subject under consideration/pluriflected should be taken into consideration and thought about
3) Phronesis retroduction is the process of moving back to the subjects of pluriflection. With as much as possible phronesis representia resulting from the phronesis and phronetic pluriduction process(ses). Meaning that the relevant and elementary results from the phronesis and phronetic pluriduction phase should be communicated with the initial subject of pluriflection. Phronesis retroductions is just the sole process of moving back towards the initial subject under consideration with this results of the phronesis and phronetic pluriduction phase
4) Then, phronduction is the latest phase of pluriflection. While phronesis abduction and phronesis retroduction are just processes of switching contexts and contents of pluriflection and mind processes in general, phronesis/phronetic pluriduction and phronduction are the essential mind processes of pluriduction. First “away” from the initial subject under consideration(s), being the phronesis and phronetic pluriduction. Then “back” with the results from the pluriduction phase. At that stage the pluriflection is however not completed. Since what is still needed there, is phronduction. Being the phronesis implementation and usage of the findings of pluriduction into the initial subjects under consideration. The result of it should be more entelychistic/excellent phronesis representia. Phronduction itself also consists of several excellent mind processes.

Phronesis pluriflection is ultimately aimed at either improving phronesis representia OR converting representamens (representamens not intelligent and sane enough to be called phronesis representia) into phronesis representia. Something VERY essential to grasp is the fact that all of the 4 phases of pluriflection as discussed and explained above are needed, but that the process itself is not something to be followed/executed only once. In the most optimal situations, there will be continuous cycles of pluriflection, constantly improving or creating existing and new phronesis representia.

Some other important parts of phronesis antenarrating can or might be one or more of the following concepts:
Stories
Deconstruction and reconstruction
Any other narrating and antenarrating methodologies

This concepts are however not subject of this patent, since this patent is solely for the characteristic parts of phronesis antenarrating methodology. Being the new notions invented by W. T. M. Berendsen and explained in this patent.

What I claim as my invention is:

1. The Phronesis Antenarrating methodology, comprising: Phronesis antenarrating, Phronetic antenarrating, Phronesis antenarrative, Phronetic antenarrative or any other methodology aimed at creating or improving Phronesis Representia based on a sane sensemaking process called pluriflection or based at least on the sole true underlying structure of our universes called holoplurality; any new notion introduced in this patent and being part of phronesis antenarrating; any combinations of Phronesis antenarrating, Phronetic antenarrating, Phronesis antenarrative, Phronesis antenarrative.

2. The methodology or notion called pluriflection, comprising: Phronesis abduction, phronesis and phronetic pluriduction, phronesis retroduction and Phronduction, based on the sole true structure called holoplurality and aimed at creating or improving Phronesis representia.

3. The notion of holoplurality, comprising: the underlying structure and nature of our universes based on plurisigns being assembled and/or disassembled; plurisigns being connected (or not) based on one or more characteristics called qualisigns

4. The methodologies and notion recited in claim 1, 2 or 3, wherein said methodology or notion consist of the same nature and/or contents of the methodology or notion as in claim 1, 2, or 3 but where synonyms for the methodology or notion are being used.

5. The methodologies recited in claim 1 or 2, wherein the contents or nature of the methodologies change but where the fundamental characteristic(s) of the methodologies still stays according to the sole true structure of our universes called holoplurality

6. The method or notion of claim 1, 2 or 3, wherein said methodology or notion is explained or specified on paper or digital storage for business or organization purposes.

7. The methodology recited in claim 1, 2, or 3, wherein said methodology is implemented for business or organization purposes using a machine.

8. A methodology or method in accordance with claim 7, wherein said machine is a computer

9. A methodology or method in accordance with claim 7, wherein said machine is involved in sense making activities.

10. The methodology recited in claim 1, 2, or 3 and those according to claim 4 or 5, wherein representamens are further explaining said methodology or any new notions used in this patent, except any texts written by W. T. M Berendsen where permission is being granted to third parties to publish or use it or even getting copyrights on this sole specific text(s) being the subject of permission of W. T. M Berendsen to the third parties concerned.
